(19) United States
(12) Patent Application Publication
(10) Pub. No.: US 2008/0147974 A1
(43) Pub. Date: Jun. 19, 2008

(54) MULTI-LEVEL CACHING SYSTEM

(75) Inventors: Justin P. Madison, Garland, TX (US); Ghousuddin Syed, Richardson, TX (US); Omar Syed, Murphy, TX (US); Thomas R. Kee, Frisco, TX (US); Sastry Anipindi, Irving, TX (US); Karl J. Juhnke, Plano, TX (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/612,296

(22) Filed: Dec. 18, 2006

(51) Int. Cl. G06F 12/00

(52) U.S. Cl. 711/118; 711/E12.001

(57) ABSTRACT

The present disclosure describes caching systems and methods for managing the storage of data file in different caching levels. Each caching level represents a faster, but more expensive, storage device or location, with the lowest level, or order, of a cache being the fastest, but also most expensive, and the highest being the slowest cache. Even slower than the various system cache levels are external file storage systems referred to as filers, such as database servers. The caching algorithm used by the system is designed so that more frequently requested items migrate to the faster cache areas. The algorithm immediately brings any requested file that is not in the cache into the fastest possible cache area if space is available or else into the next fastest if space is available there. If all cache areas are full, then the file is cached to the highest ‘order’ number cache area.

### BACKGROUND

Large files, such as media files like video and audio streams, are now commonly streamed or otherwise served over computing networks such as the Internet. When responding to requests to transmit large files, it is preferable to reduce to a minimum the amount of delay between receipt of these requests and the initiation of the streaming of the data back to the requestor. One large cause of delay is the time it takes the server receiving the request to find and retrieve the requested file from the large database servers on which they are typically stored.

### SUMMARY

The present disclosure describes caching systems and methods for managing the storage of data files in different caching levels used in conjunction with servers that stream content or otherwise transmit data in response to requests. In an embodiment, each caching level represents a faster, but more expensive, storage device or location, with the lowest level, or order, of a cache being the fastest, but also most expensive, and the highest being the slowest cache. Even slower than the various system cache levels are external file storage systems referred to as filers, such as database servers. The caching algorithm used by the system is designed so that more frequently requested items migrate to the faster cache areas. The algorithm immediately brings any requested file that is not in the cache into the fastest possible cache area if space is available or else into the next fastest if space is available there. If all cache areas are full, then the file is cached to the highest ‘order’ number cache area.

One aspect of the disclosure describes a method of caching requested files. The method includes receiving a request for a requested file in a remote storage location and the requested file not contained in a cache, wherein the cache includes a plurality of different levels having different performance characteristics. The method also searches each of the plurality of different levels of the cache for the requested file in an order based on the different performance characteristics. The method also adds information identifying the requested file to a list of files to be copied from the remote storage location into the cache.

Another aspect of the disclosure describes a method of caching requested files that includes receiving a notification of a request for a requested file stored in a remote storage location and the requested file not contained in a cache and searching, in an order based on the different performance characteristics, each of the plurality of different levels of the cache for sufficient space to store the requested file.

Another aspect of the disclosure is a method of caching requested files that includes receiving a request for a requested file stored in a remote storage location in which a copy of the requested file is also stored in a first cache level of a local cache. In addition, the local cache includes a plurality of different cache levels including the first cache level and each cache level in the plurality of different cache levels has different performance characteristics such as response speed. The method further includes serving the copy of the requested file from the first cache level and moving the requested file from the first cache level to a second cache level, the second cache being a faster cache level in the plurality of cache levels relative to the first cache level.

Yet another aspect of the disclosure is a computer-readable medium encoding computer-readable instructions for performing a method of caching requested files. The method includes receiving a request for a requested file stored in a remote storage location, in which a copy of the requested file is also stored in a first cache level of a local cache. The local cache includes a plurality of different cache levels including the first cache level and each cache level in the plurality of different cache levels has different performance characteristics. The method further includes searching each of the plurality of different cache levels of the local cache for the requested file in an order based on the different performance characteristics. The method further includes adding information identifying the requested file to a list of files and serving the copy of the requested file from the first cache level. In addition, the method further includes reading the list of files and, in response to reading the information identifying the requested file, moving the requested file from the first cache level to a second cache level, in which the second cache level is a faster cache level in the plurality of cache levels relative to the first cache level.

Yet another aspect of the disclosure is a system for serving data to a client computing device including a media server module that receives client requests for files stored in one or more remote storage devices. The system further includes a local cache storing at least one copy of one or more files stored in the one or more remote storage devices. The local cache includes a plurality of different cache levels, in which each cache level in the plurality of different cache levels has different performance characteristics. The system also includes a cache management module that moves cached files from a slower cache level to a faster cache level in response to request notifications. The system also includes a caching component that transmits request notifications to the cache management module in response to client requests received by the media server module, in which each notification identifies a requested file and whether a copy of the requested file exists in the cache.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of systems and methods described below and are not meant to limit the scope of the invention in any manner, which scope shall be based on the claims appended hereto.

FIG. 1 illustrates an embodiment of a media server caching system.

FIG. 2 is an embodiment of a method of serving a requested file from a cache performed by the CCP.

FIG. 3 illustrates an embodiment of a method of managing the cache performed by the CMD.

FIG. 4 illustrates an embodiment of a method of analyzing the caching level of requested files.

FIG. 5 illustrates an embodiment of a method of caching a requested file that, upon request, is not contained in the cache.

FIG. 6 illustrates an alternative embodiment of a method of analyzing the caching level of requested files.

### DETAILED DESCRIPTION

The present disclosure describes caching systems and methods for managing the storage of data file in different caching levels. In an embodiment, each caching level represents a faster, but more expensive, storage device or location, with the lowest level, or order, of a cache being the fastest, but also most expensive, and the highest being the slowest cache. Even slower than the various system cache levels are external file storage systems referred to as filers, such as database servers. The caching algorithm used by the system is designed so that more frequently requested items migrate to the faster cache areas. The algorithm immediately brings any requested file that is not in the cache into the fastest possible cache area if space is available or else into the next fastest if space is available there. If all cache areas are full then the file is cached to the highest ‘order’ number cache area.

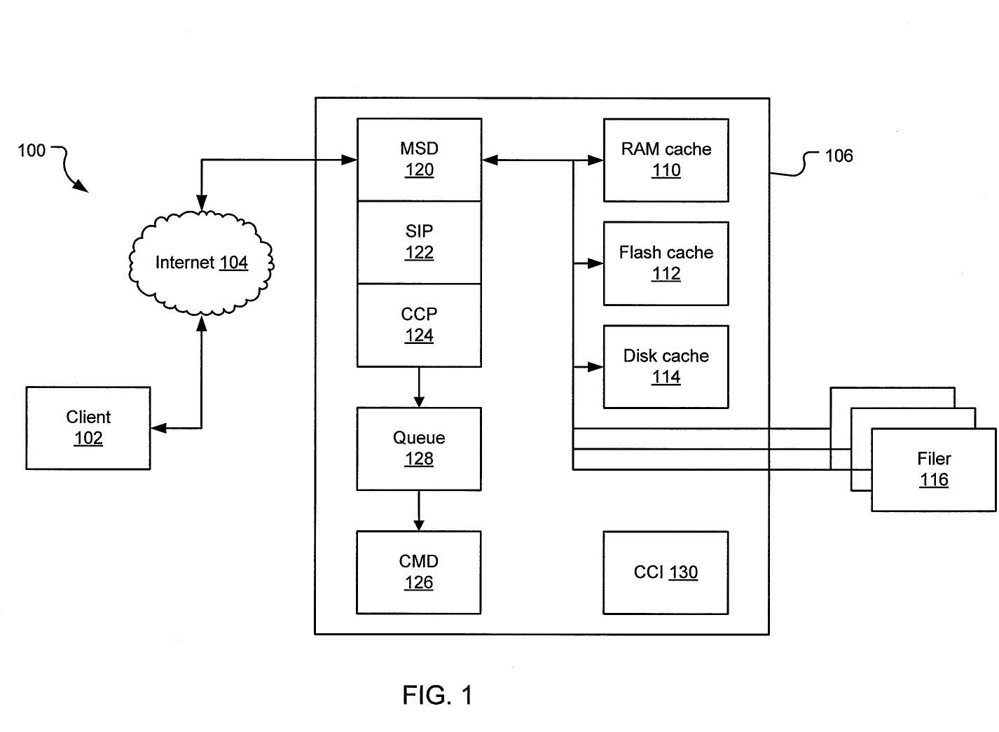

FIG. 1 illustrates an embodiment of an architecture for streaming, serving or otherwise transmitting media via a media server caching system. In the architecture, requests for media content are directed from clients (e.g., the client 102) to the media server host 106 via a network such as the Internet 104. In response to the request, the media server host 106 identifies the requested media content and transmits it to the requesting client 102. The systems and methods described herein relate to how media content on the media server host 106 is cached in order to efficiently respond as quickly as possible to the client requests.

In the architecture 100, the various computing devices are connected via a network 104. One example of a network 104 is the Internet. Another example is a private network of interconnected computers, however, any communication network, now known or later developed, may be used including for example a cellular phone network, a simple text messaging network, a paging network or some other network. The format and contents that are communicated between the various computing devices may differ depending on the network used. For example, if the Internet 104 is the network the communications may take the form of Hypertext Transfer Protocol (HTTP) requests and responses in which data files are transferred between devices. If the network is a mobile telephone network such as a Global System for Mobile Communications (GSM) network, communications may comply with some other communication protocol such as the Short Message Service (SMS) Point-to-Point protocol.

Examples of computing devices suitable for use in a distributed computing architecture 100 are well known in the art, e.g., personal computers and purpose-built server computers, and need not be described in detail herein. By way of example and not limitation, a client 102 can be any computing device capable of requesting and receiving data from another computing device. Examples of common client computing device include personal computers (PC), web enabled cellular telephones, personal digital assistants (PDA) or the like, capable of receiving data over the network 104, either directly or indirectly (i.e., via a connection with another computing device). By way of further example, server computing devices may be any computing device that can “serve” a request by receiving the request for data from the client and responding by accessing the requested data and transmitting that data to the client.

By way of example, computing devices such as the client 102 or the server 106 generally include a processor and memory for storing data and software. Computing devices may further be provided with operating systems and may be able to execute software applications in order to manipulate, transmit and receive data. In the computing device, files may be stored on one or more local or remote storage devices 110, 112, 114, 116 that are connected to or part of any of the computing devices described herein. A storage device and its associated computer-readable media provide non-volatile storage that can be accessed by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In the embodiment shown, the media server host 106 is provided with several different storage areas 110, 112, 114, 116 which may be used to store media content. Each storage area, which may be referred to as different caching areas or levels, represents a different type of storage media with different performance characteristics related to cost and speed (i.e., the rate at which data can be transferred in response to a request). In the embodiment shown, the fastest caching level is the random access memory (RAM) cache 110. The RAM cache 110 is the fastest but also the most expensive cache to operate. The next fastest caching level is the flash cache 112, followed by the media server host's local disk cache 114, and finally the remote filers 116, which is a general term for a remote database server, datastore or other remote data storage device. Examples of each of these levels of caching and the components that are used therefore are well known in the art and need not be discussed in detail herein. In general, for the remainder of this specification the general term “cache” will be used to refer to all local storage including the RAM cache 110, flash cache 112 and disk cache 114, as opposed to remote devices such as filers 116 and noting that the cache will have different “areas” or “levels” that may correspond to different types of cache within the system, e.g., RAM cache versus disk cache as two different levels of cache or two different disk caches as two different areas of cache.

In the embodiment shown, the media server host 106 is provided with a media server daemon (MSD) 120. Requests for media content are processed by the MSD 120. A request may have a URL like: mms://server01.best.yahoo.com/path/file.wmv?sid=123& auth=hashString. The MSD 120 will pass the request to the Server Interface Plugin (SIP) 122 to determine which file is to be served and interact with the requesting client to deliver the file. The MSD 120 is not really part of the caching system, but rather a program which uses the caching system.

The SIP 122 provides a routine which is loaded into the MSD 120 and is invoked when there is a request. The routine is given the query string parameters. The SIP 122 does some initial validation of the parameters and also authenticates the request if secure content is being accessed. The SIP 122 also does any mapping that is required to convert the requested file path to a physical file system path that is accessible by this media server host. If these steps succeed it invokes the Caching Component Plugin (CCP) 124 and passes the query string parameters to it and gets a string specifying the file to be served. This string is passed back to the MSD 120. The SIP 122 may be very specific as to the type of MSD 120 it interfaces with, thus further specifications of this component is beyond the scope of this document.

The CCP 124 provides a routine which is invoked by the SIP 122 when there is a request. This routine is given a subset of the query string parameters and returns a string that specifies a file system path and name of the file to be served. This plugin 124 will be independent of the MSD 120 and can be used with any MSD 120 that has an appropriate SIP 122. The CCP 124 does not do any authentication checking and assumes that it will be done by the SIP 122. The CCP 124 sends messages to the Cache Manager Daemon (CMD) 126 through a queue 128.

The CMD 126 is a program that is started at system boot time and is continually running. It is solely responsible for managing all the cache available on the system. The CMD 126 looks at the cache miss/hit messages from the CCP 124 and invokes other processes to copy content from the original source to the cache, or between caches. It also looks at the remaining cache space available and removes content from the cache.

The media server host 106 further includes a cache control interface (CCI) 130. In an embodiment, the CCI 130 is a web service running on the media server host 106. It processes the web requests to allow pre-caching of content, removal of content and querying the cache status and configuring the caching system. It provides both a programmatic interface and a human interface. In an embodiment, the CCI 130 is an internal interface and is not accessible to the public.

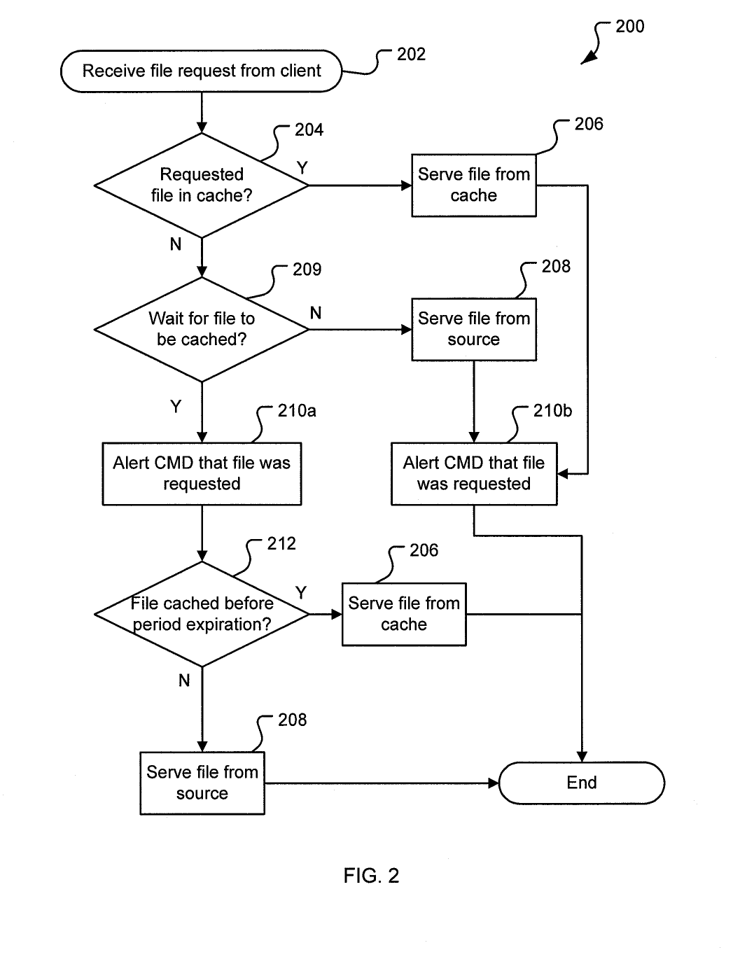

FIG. 2 is an embodiment of a method of serving a requested file from a cache performed by the CCP. In the method 200, a request for a file is received in a receive request operation 202. As described in greater detail below, the requested file is identified in a way that designates the file and its original source, i.e., the remote device or filer 116 that serves as the file's primary location. In addition, the request may also identify or may be associated with a client.

In response to the request, for a typical request the CCP determines if the file is in the cache by searching the cache for the requested file in a first determination operation 204. If the file is found, it is served to the client in a serve from cache operation 206.

If the file is not found, then a second determination operation 209 is performed in which it is determined if the CCP 124 should wait for the CMD 126 to cache the requested file or to serve the file directly from the source. As discussed in greater detail below, this determination is made based on a comparison of the estimated time that it would take to cache the requested file against a predetermined threshold. If the estimated time to cache is greater than the threshold, then the requested file is served from the file's source, e.g., a filer 116, in a server from source operation 208.

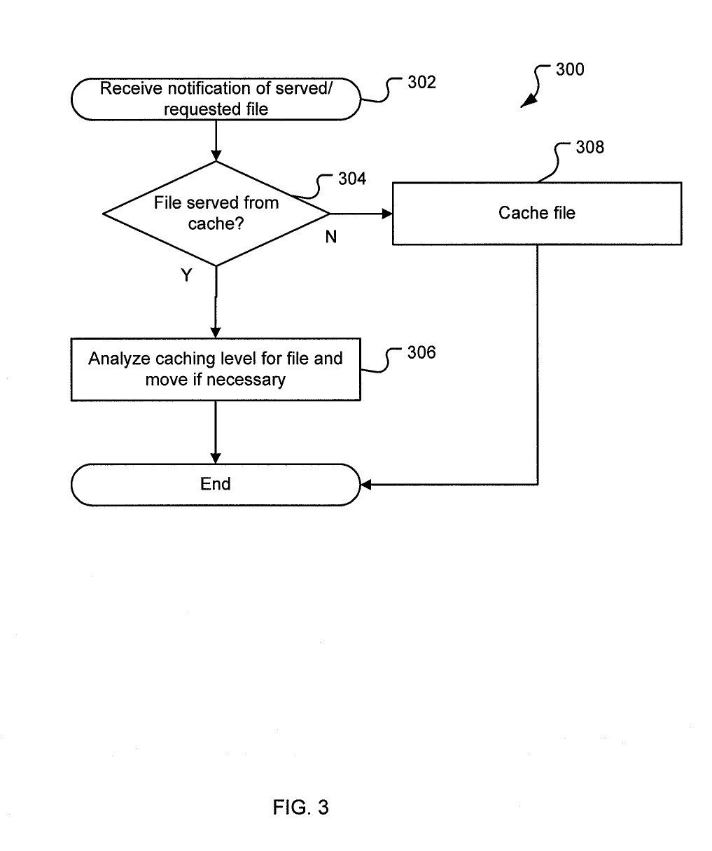

In the embodiment shown, upon serving the requested file from either the file's source or the cache, an alert operation 210b is performed. After serving the requested file, the CCP 124 then alerts the CMD 126 that the file was requested in an alert operation 210b. In alert operation 210b, the CCP 124 communicates to the CMD 126 that the requested file was served and when it was served so that the CMD 126 can then determine how or if to adjust the caching of the requested file as described in FIG. 3. In an embodiment, the alert operation communicates this information to the CMD 126 by writing the appropriate data into the queue 128. As will be described in greater detail below, the CCP 124 may also provide additional information about the request including where the file was served from and what client requested the file. After serving the file and alerting the CMD 126 in the alert operation 210b, the processing of that file request ends.

The two alert operations 210a and 210b are illustrated in FIG. 2. The other alert operation 210a occurs at a different point in the process flow, but is otherwise the same operation as the one 210b discussed above. The second alert operation 210a occurs if the second determination operation 209 determines that the estimated time to cache is less than the threshold. In this situation, as shown, the method 200 will not serve the file, but rather alert the CMD 126 of a requested file in an alert operation 210a.

After this alert operation 210a, the CCP 124 will periodically check to determine if the requested file has been cached until the expiration of a predetermined timeout/wait period. This is illustrated by a third determination operation 212. If the third determination operation 212 determines that the file is cached prior to the expiration of the waiting period, the requested file is served from the cache in another of the serve from cache operation 206 that is identical to that described above with the exception of its location within the operational flow. If the third determination operation 212 determines that the file has not been cached by the expiration of the waiting period, the requested file is served from the source in another of the serve from source operation 208 that is identical to that described above with the exception of its location within the operational flow. In either case, after the file has been served, the processing of that file request ends as shown.

Together, the second and third determination operations 209 and 212 can be considered a waiting operation. The point of waiting is that if the CCP 124 doesn't wait, the filer has to serve the source twice: once for the user's immediate consumption in the serve file from source operation 208 and again when the CMD 126 places a copy of the requested file in the cache (see, e.g., FIG. 3). By waiting, the filer only has to serve it once, to the CMD 126, and the user is served from the copy the CMD 126 places in cache. Depending on the embodiment, waiting may occur not only for all small files, but also for arbitrarily large files in which the user can't seek forward. For files of the latter type, the user is served from cache while the CMD 126 is still copying into the cache, so the CCP 124 is really only waiting for the _beginning_ of the file to appear in cache.

FIG. 3 illustrates an embodiment of a method of managing the cache performed by the CMD 126. In the method 300, the CMD 126 is alerted that a file has been served or requested by the CCP 124 in a receive notification operation 302. As discussed in greater detail below, this may be done by transmitting the appropriate information to the CMD 126 or by the CMD 126 accessing a file structure, database or table in which the CCP 124 stores the alert information.

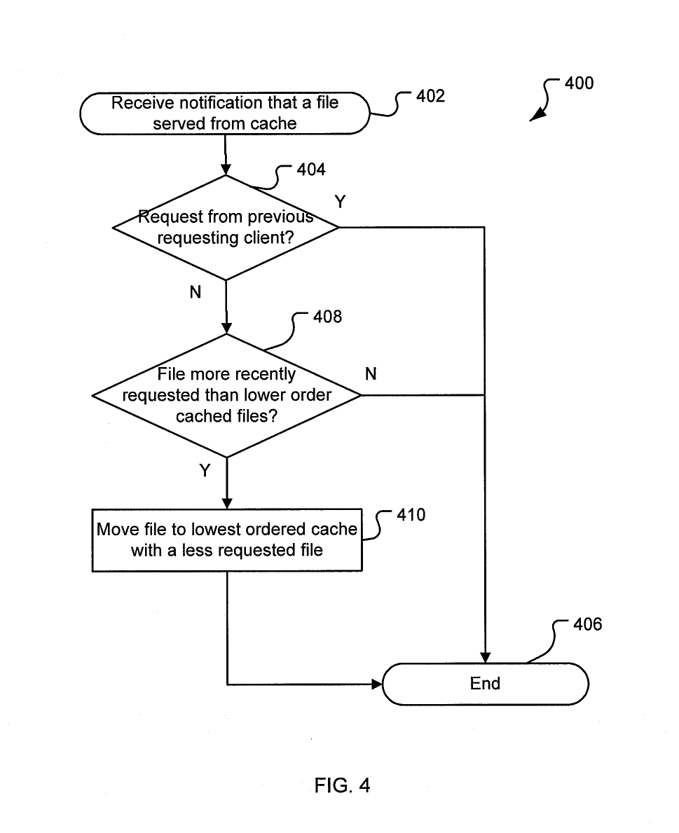

Regardless of how the information is communicated to the CMD 126, the CMD 126 next determines if the requested file was served from the cache in an first determination operation 304. If the file was served from the cache, a caching level analysis operation 306 is performed and it is determined if the file should be moved to a lower order (i.e., faster) cache based on the information provided by the CCP 124. The caching level analysis operation 306 is described in greater detail with reference to FIG. 4 and in the discussion of the operation of the CMD 126 below.

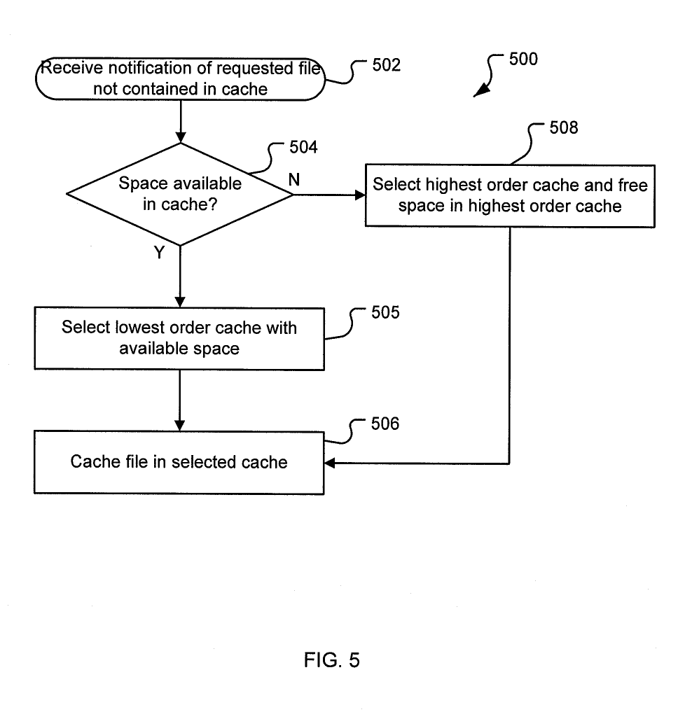

If the file was not served from the cache, but rather from its original source or if the CCP 124 is waiting for the file to be cached, a cache file operation 308 is performed in which the CMD 126 moves or at least attempts to move the requested file into the cache. The cache file operation 308 is described in greater detail with reference to FIG. 5 and in the discussion of the operation of the CMD 126 below.

FIG. 4 illustrates an embodiment of a method of analyzing the caching level of requested files. The method 400 shown may be used to perform the analysis operation 306 described above. In the method 400, the CMD 126 receives information that a file has been requested and that the file is located in the cache in a receive notification operation 402. The notification includes information about the file request including the file name and the requesting client. Additional information may also be provided as discussed below. The file may or may not have been served from the cache depending on the embodiment.

In response, the CMD 126 first determines based on the information provided about the file request if the request is from the client that previously requested the file in a first determination operation 404. In the first determination operation 404, the CMD 126 compares the client identifier for the current request (i.e., the request in the notification received in the previous operation 402) to the data about the same file in the cache. As part of the information stored in the cache about cached files, the cache includes an identifier of the last client that requested each cached file. In the first determination operation 404, if the requesting client identifier in the notification and the last client requesting the file in the data in the cache are the same, the request is not considered a request that should change the caching level of the file and the CMD 126 terminates processing of this request in a termination operation 406.

However, if the requesting client identifier in the notification and the last client requesting the file in the data in the cache are different clients, then the CMD 126 performs a second determination operation 408 to determine if the requested file was requested more recently than any of the files in the lower order caches. The CMD 126 performs this analysis so that each order of the cache is maintained with the most recently requested files in the lowest order caches. It has been determined in simulations that this determination reduces the unwanted chum in the cache and improves the performance of the system.

In the second determination operation 408 the time of the request for the requested file is compared to the time of the least recently requested files in each of the lower order caches. If the requested file's request time is not more recent than any of the cached files' request times in any lower order cache, the method 400 terminates in the termination operation 406. This has the effect that the requested file remains in the cache level from which it was served. In addition, if the requested file is already in the lowest order cache, the requested file's request time is then at least equal to the least recently-requested file's request time in the lowest order caching level and the method 400 also terminates in the termination operation 406.

However, if the requested file's request time is more recent than any of the cached files' request times in any lower order cache, the CMD 126 will move the requested file to the lowest order cache for which the requested file's request time is more recent than any of the cached files' request times in a move into lower order cache level operation 410. Moving entails copying the requested file from the higher order cache level to the selected lower order cache level and then deleting the file from the higher order cache level. Moving may require the CMD 126 to free enough space in the selected cache level. In an embodiment, this is done by deleting the least recently requested file or files from the selected caching level until enough space is made in the selected caching level for the requested file to be moved. In addition, as described below the CMD 126 may perform various sub-operations such as searching for older or orphaned versions of cached files that may be located within a cache in order to delete those files to free up space.

The move into lower order cache level operation 410 may move the file to the lowest order of cache for which the requested file's request time is more recent than any of the cached files' request times as shown. However, in an alternative embodiment, moving may only entail moving the file to the next lowest order of cache and doing this only if the requested file's request time is more recent than the least recently requested file cached in the next lowest order. The reader should understand that if there are only two orders of cache, then these alternatives are functionally equivalent.

Generally, the methods 300, 400 of FIGS. 3 and 4 have the effect of causing files that are heavily requested to be maintained in the lowest order (i.e., fastest) caching level. Less requested files will be deleted out of the cache entirely, to be brought back in as they are requested from their source in subsequent requests as discussed with reference FIG. 5 and in the discussion of the operation of the CMD 126 below.

FIG. 5 illustrates an embodiment of a method of caching a requested file that, upon request, is not contained in the cache. The method 500 shown may be used to perform the cache file operation 308 described above. In the method 500, the CMD 126 receives information that a file has been requested and that the file is not located in the cache but at its original source in a receive notification operation 502. The notification includes information about the file request including the file name and the requesting client. Additional information may also be provided as discussed below. The file may or may not have been served from the cache depending on the embodiment.

In response, the CMD 126 first determines if space is available in the cache in a first determination operation 504. If space is available, then the lowest order cache level with available space is selected in a select cache operation 505 and the requested file is cached in the selected cache level in a cache file operation 506. In an embodiment, the first determination operation 504 may include looking at each cache level starting with the lowest cache level to determine the available space and stopping when the first instance of a cache level with available space is identified. To determine the available space, the first determination operation 504 may also include retrieving size information about the requested file from the file's source.

If space is not available in any level of the cache, the method 500 selects the highest order cache and proceeds to free space in the highest order of the cache in a select and free space operation 508. This will cause at least some files to be deleted from the highest level of the cache as described above and elsewhere in this application. After freeing sufficient space in the highest order of the cache, the file is cached in the selected cache in the cache file operation 506.

The method 500 causes a newly requested file that is not already cached to be cached in the lowest order cache level possible without deleting any cached files. However, if the cache is already full, the newly requested file is cached into the highest order (i.e., the slowest) cache level. When combined with the method of FIG. 4, this allows a file to be cached into the highest order cache level by the method of FIG. 5 and the file to be subsequently upgraded into the lower order cache levels by the method of FIG. 4. Together, the methods described above decrease the response time for serving popular files by preferentially locating those files in the fastest (lowest order) cache levels available to the server.

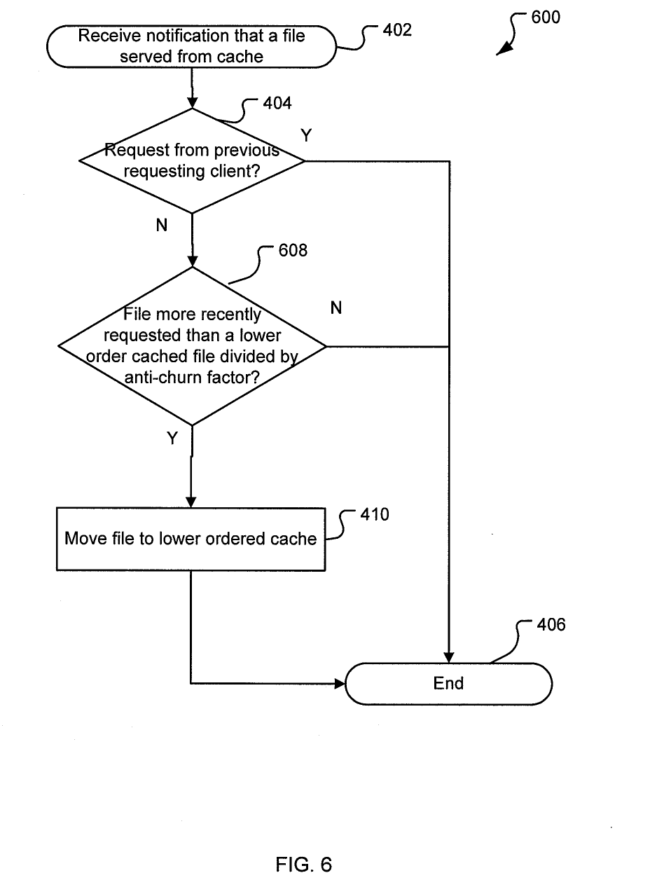

FIG. 6 illustrates an alternative embodiment of a method of analyzing the caching level of requested files. In the embodiment shown, the operations performed by the method 600 are the same (and identified by the same reference numerals) with the exception that the second determination operation 608 includes additional analysis. In FIG. 4, the policy of operation 408 was to promote an item if its time-since-last-use is less than the time-since-last-use of some item in a faster cache. However, the item paged out is possibly the unluckiest item in the faster cache, as opposed to merely the least popular item in the faster cache. If a cache has 1000 items, all of which are getting hit randomly at a rate of once per minute, then the odds are that some item hasn't been hit in six minutes just by bad luck. If that unlucky item is removed for one which is being accessed every three minutes in the slower cache, then unacceptable churn may occur.

To address this possibility, the method 600 of FIG. 6 modified the second determination operation 608 to include an “anti-churn factor”, which can be empirically set to a constant for each cache level, or dynamically calculated as the logarithm of the number of files in the cache. In the method 600 of FIG. 6, the policy is to promote an item to a faster cache if its time since last use is less than that of the least recently used item in the faster cache divided by the anti-churn factor. Thus, the second determination operation 608 includes calculating the anti-churn factor and comparing the time of the request for the requested file to the time of the least recently requested files in each of the lower order caches as modified by the anti-churn factor. In an embodiment, the anti-churn factor may the natural logarithm of the number of items in the faster cache. Other anti-churn factors may also be used as well as algorithms that account for the statistical possibility that a least recently requested item in the lower order cache is in fact a more popular item than the one being evaluated. Any such factors and algorithms may be adapted for use in this operation 608.

Various embodiments of the operations described above with reference to FIGS. 2-5 are described in further detail below.

### Example of the Operation of an Embodiment of the Caching Component Plugin (CCP) 124

Upon initialization, the CCP 124 reads in a list of cache areas, such as the caches 110, 112, 114, 116. To serve a request for a file received from a client 102, the CCP 124 looks for the requested filename in each of the cache areas. If it finds the file then the file is served from the cache. If it does not find the file, the file is served from the original source, e.g., a filer 116. The CCP 124 writes to a queue to let the CMD 126 know if the request was a miss or a hit. The CCP 124 does not require any database or in memory data structure to model any of the caches or find the requested file. In some cases the CCP 124 may wait for a short time to see if the requested file is being brought into the cache and serve the file directly from cache. This is only done for very small files or for requests in which the user cannot seek forward in the file. The point of waiting is that if the CCP 124 doesn't wait, the filer has to serve the source twice: once for the user's immediate consumption in the serve file from source operation 208 and again when the CMD 126 places a copy of the requested file in the cache (see, e.g., FIG. 3). By waiting, the filer only has to serve it once, to the CMD 126, and the user is served from the copy the CMD 126 places in cache. Depending on the embodiment, waiting may occur not only for all small files, but also for arbitrarily large files in which the user can't seek forward. For files of the latter type, the user is served from cache while the CMD 126 is still copying into the cache, so the CCP 124 is really only waiting for the _beginning_ of the file to appear in cache.

The CCP 124 can also accept a ‘nocache’ parameter in the request which forces it to serve the file from the original source and not from cache. In addition a ‘disableCaching’ configuration parameter allows turning off caching of new content as well as forcing the request to be served from the original source.

When initialized, the CCP 124 reads in one or more configuration files in order to obtain the necessary information for locating and accessing the various caches available. In addition to this information, in an embodiment the CCP 124 also reads in information, e.g., from a table maintained by the CMD 126, about the transfer rates of one or more of the caches. In an embodiment, the table is referred to as the ‘transferRatesTable’ and the table includes a list of sources and a rate associated with each source. The ‘source’ is a unique string identifying a filer 116 or other device from which the content is transferred to the cache. The ‘rate’ is the number of bytes that can be transferred from it in a second. The CMD 126 keeps transfer rate statistics for all devices that it encounters in the process of bringing content into cache and publishes the rates in the ‘transferRatesTable’. The CCP 124 will use these rates to determine how long it would take to bring a requested file into cache and if the time is smaller than a value specified elsewhere then it will serve the file as it is being written to cache.

The CCP 124 has been designed to continue running using embedded default values even if it is not able to read any of the above configuration information from an embedded database.

The CCP 124 will be passed the following inputs from the SIP 122 on each request:

path—specifies the path and file being requested;

sid—specifies the stream id of the requested file; sid or path must be given;

clientid—specifies the client id of the requesting client; can be the IP address or a session cookie identifying the client; may not be given;

nocache—specifies that the request must not be served from cache but instead from the location specified by path; defaults to 0 if not given. Also the content should not be cached if it is not already in the cache; and

noseek—if this is set then it means the client will not be able to seek forward/back while consuming the content and so the CCP 124 can serve the content from cache while filling the cache; defaults to 0 if not given.

If the ‘path’ parameter is given then the ‘sid’ parameter is ignored. If the ‘path’ parameter is not given the CCP 124 will return a path-error. In the future if the ‘path’ parameter is not provided and the ‘sid’ is provided the CCP 124 will query a service (giving it the ‘sid’) to determine the ‘path’, but currently it does not need to do this. If both the ‘path’ and ‘sid’ parameters are not given the CCP 124 will return a path-error.

The SIP 122 should try to set the ‘clientid’ based on a cookie which identifies the user or the browser. If this is not possible the SIP should try to set the ‘clientid’ based on the IP address of the request. If this is also not possible, the ‘clientid’ will not be passed to the CCP 124. In such a case the CCP 124 should initialize the ‘clientid’ to a large unique or random number such as the current time stamp concatenated with a random number.

If the ‘nocache’ parameter is provided in the input request and set to 1, then the CCP 124 needs to try and serve the request from the given path instead of the cache. First it checks to see if the ‘allowNoCache’ parameter is set to 0 in the configuration hash. If it is set to 0 or not specified then it returns a nocache-error to the SIP. If it is 1 then the CCP 124 must try to serve the request from the specified ‘path’ and not look in the cache. If the file specified by ‘path’ does not exist then it must return a path-error. Note that whenever the CCP 124 checks for the existence of a file specified by ‘path’ it should use a separate process or thread since this may block if the network device is down. If a response is not received in ‘netFileInfoReadWaitSeconds’ then the CCP 124 should return a path-error.

If the file exists the CCP 124 can return the ‘path’ back to the SIP 122 and send a message to notify the CMD 126. In an embodiment, the CCP 124 uses a table, referred to herein as the ‘cacheRequestDir,’ to transfer information about file requests handled by the CCP 124 to the CMD126. The CCP 124 transmits to the CMD 126 such information as the requested filename, and the time of the request. Other information may also be provided such as information about whether to cache the file or not and which client requested the file.

In an embodiment, the CCP 124 appends the ‘filename’, the string “nocache”, the ‘clientid’, the current timestamp (e.g., resolved to at least one milli-second) and the ‘path’ parameter followed by a new line character into the ‘cacheRequestDir’ itself, or into a predesignated table stored within the ‘cacheRequestDir’ depending on the embodiment. The name of the requested file as listed in the table may be ‘ts’_‘filename’ where ‘ts’ is the current timestamp. Alternatively, the timestamp may be provided in as a separate field in the string. Other methods of transferring information are also possible. For example, in an alternative embodiment, the CCP 124 may create a file within a directory, as opposed to a new line in a table. In yet another embodiment, messages may be sent to an input queue operated by the CMD 126.

Caching may be disabled within the CCP 124. In an embodiment, if the ‘disableCaching’ configuration parameter is set to “all” the CCP 124 may attempt to serve the request from the specified path and bypass the search of the cache. If the file specified by ‘path’ does not exist then it must return a path-error. Otherwise it can return the ‘path’ back to the SIP 122 and create a file in the ‘cacheRequestDir’ as described in the previous section. However the string “nocache” is replaced with “disabled”. If the ‘disablecaching’ parameter is set to anything else (like “CMD”) the CCP 124 will process the request as normal.

In an embodiment, for a regular request that is to be served from cache if possible, the CCP 124 determines the filename and directory from the ‘path’ parameter. Once the CCP 124 determines the filename and subdirectory, it will look in each of the cache areas that are in its array (in order from top to bottom) for a file with this filename and stop after it finds the first one. The complete path may be [cache area path]/[subdirectory]/[filename].

In an embodiment, secure content may be further identified, for example by providing an extra string in the path. In an embodiment, for secure content requests verifying authentication for secure content is done by the SIP 122 and will not be done by the CCP 124. However, the CCP 124 does check to see if the requested content is secure and preserves that information in its response. To check if the requested content is secure the CCP 124 looks for the security string anywhere in the ‘path’. If it is found then this request is assumed to be for secure content. The CCP 124 preserves this by appending secure string to the cache area path in its response and when looking for the file. The SIP 122 may also consider secure string to mean secure content and verify authentication.

If the requested file is found in one of the cache areas, it is referred to as a cache hit and the CCP 124 can proceed as described hereafter.

As part of the searching of the cache for the file, the CCP 124 may check to determine if a cached copy of the requested file is stale (i.e., the original file on the filer has been modified since the copy was made). In an embodiment, this check is only done if the ‘checkOriginSync’ configuration parameter is set. If the ‘checkOriginSync’ configuration parameter is set then the CCP 124 checks the last modified time of the original file (specified in ‘path’) in the filer 116 with the copy in cache.

Depending on the embodiment, different actions may be performed if a stale file is found in the cache. In a first embodiment, if the modified time of the copy in cache is older than the original then this request must be treated as a cache miss and further processing should proceed as described below. In a second embodiment, if the modified time of the copy in cache is older than the original, then the CCP 124 communicates to the CMD 126 that the cached copy is stale, for example by listing the ‘hitMiss’ parameter as ‘stale’ rather than ‘miss’. This triggers the CMD 126 to delete it from all cache areas, and page it in to the fastest cache area in which it was found. Thus a stale file isn't paged into the slowest cache area as a regular miss would be.

In an embodiment, checking for existence of the original file or its modified time is done using a separate process or thread and waiting ‘netFileInfoReadWaitSeconds’ for the response, since these operations could block if the source is unavailable. If the source is unavailable the CCP 124 may assume that the file in cache is in sync and can be served.

As part of serving the file from the cache, the CCP 124 updates the last modified time of the file to the current time. This is so that the CMD 126 will not delete the file from cache as it is being served. To serve the file, the CCP 124 returns back to the SIP 122 the string: [cache area path]/[subdirectory]/[filename]. Note that the cache area path may have had security string appended to it if this was a request for secure content.

In addition to responding to the SIP 122, the CCP 124 also alerts the CMD 126 that the file was served. In an embodiment, this is done by adding information identifying the served file to a data structure periodically read by the CMD 126. Alternative methods of alerting the CMD 126 are also possible.

In an embodiment, the CCP 124 lists each served file in a table, referred to as the ‘cacheRequestDir’. If the number of files in the ‘cacheRequestDir’ is more than the ‘maxRequestFiles’ configuration parameter the CCP 124 cannot create another message file to pass back to the CMD 126 and logs an error message about this condition. Otherwise the CCP 124 appends the ‘filename’, the [cache area path], the ‘clientid’, the current timestamp (resolved to at least one milli-second) and the ‘path’ parameter followed by a new line character to a file in the ‘cacheRequestDir’. The name of the file could be ‘ts’_‘filename’ where ‘ts’ is the current timestamp resolved to at least one milli-second. The CMD 126 subsequently checks the ‘cacheRequestDir’ directory and processes the requests as described elsewhere herein in order to manage the cache.

If the requested file is not found in any of the cache areas, referred to as a ‘cache miss’, the CCP 124 determines if it will wait for the missed file to be brought into cache or if it will serve the request from the original source specified by the path parameter. In an embodiment, several conditions will affect this decision. For example, in an embodiment the CCP 124 will check the ‘noseek’ parameter. If the ‘noseek’ parameter was set to 0 or is not specified the CCP 124 will not wait.

As another example, the CCP 124 may check the estimated time to bring the file into cache from the transfer rate table. If the estimated time to bring the file into cache would be greater than predetermined amount, the CCP 124 may not wait. The time to bring the file into cache is computed as: the size (in bytes) of the requested file divided by the transfer rate of the ‘source’. The ‘source’ is determined by checking if any of the sources listed in the ‘transferRatesTable’ is contained in the ‘path’. The first match is considered to be the source and the corresponding ‘rate’ is used in the above calculation.

If the number of files in the ‘cacheRequestDir’ is more than the ‘maxRequestFiles’ configuration parameter the CCP 124 cannot create another message file to pass back to the CMD 126 and may log an error message about this condition. Otherwise the CCP 124 appends the filename, the string ‘miss’, the ‘clientid’, the current date/time, the ‘path’ parameter from the request and the string ‘waiting’/‘notwaiting’ followed by a new line character to a file in the cache request directory. The name of the file will be as described in the cache hit section above. The CMD 126 then subsequently checks the request directory and brings the missed files into cache as described below.

If the CCP 124 has decided to wait for the requested file (and wrote ‘waiting’ in the file of the previous step) then the CCP 124 will wait a maximum of ‘maxWaitSeconds’ for the file to appear in cache. In an embodiment, while waiting the CCP 124 will pole the file it created in the ‘cacheRequestDir’ until the file is deleted. The CCP 124 pauses or sleeps for ‘poleWaitSeconds’ between checks. Once the file is deleted it will check the cache area with the highest ‘order’ number for the requested file. If not found it will continue checking again after pausing for ‘poleWaitSeconds’. When the file is found the CCP 124 serves the file by returning back to the SIP 122 the appropriate string as described above.

In an alternative embodiment, the CCP 124 may wait for a predetermined period of time and check the cache. If the file is not in the cache after this period of time, the CCP 124 may serve the requested file from the filer 116. Other methods for waiting are also possible.

If the CCP 124 has decided not to wait for the requested file or if the maximum wait time was reached it will return the ‘path’ parameter back to the SIP 122.

### Example of the Operation of an Embodiment of the Cache Manager Daemon (CMD) 126

The caching algorithm used by the CMD 126 supports multiple levels of cache areas that are ordered with the faster cache areas having a lower ‘order’ number. The algorithm is optimized for situations in which faster cache areas (e.g., RAM cache 110) have a smaller capacity than slower ones (e.g., disk cache 114) and that more frequently requested items should migrate to the faster cache areas. As described above, the algorithm immediately brings any missed file into the fastest possible cache area if space is available or else into the next fastest if space is available there. If all cache areas are full then the file is cached to the highest ‘order’ number cache area. Thus the “page in” policy of the algorithm can be described as a most recently used (MRU) policy.

If the capacity limits of a cache area would be exceeded by the file to be brought in, the algorithm must select one or more files to remove from the cache. The files to be removed are selected based on recency of use. Thus the “page out” policy can be described as a least recently used (LRU) policy.

If a file is already in a cache area and is requested again then it may be a candidate to be moved to the next lower ‘order’ number (faster) cache area, as described above with reference to FIGS. 4 and 6. In an embodiment, for this to occur several conditions may have to be met. First the end user requesting the file must be different than the one who requested the file last time. Second the last time this file was requested must be more recent than the oldest last requested time of the files in the next lower ‘order’ number cache area. It has been found in simulations that these conditions help reduce the churn in smaller (faster) cache areas while increasing the chance of the cached file being served again. Embodiments of the caching algorithm may also support scheduled precaching and keeping selected files in cache for a specified period of time, as will be discussed in greater detail below.

As part of its initialization, the CMD 126 accesses configuration information about the caching areas available for use. In this way, the CMD 126 is aware of what cache levels are available, how to access them, and various technical details about each cache level such as its size. For example, in an embodiment the CMD 126 reads the information from a file called the ‘cacheAreasTable’ and obtains from that table a cache path (from a field designated ‘cachePath’), the maximum cache size in bytes (from a field designated ‘cacheMaxSize’), a cache type such as RAM or disk (from a field designated ‘cacheType’), a maximum file system percent based on cache size (from a field designated ‘cacheMaxPercent’) and a cache order or level identifier (from a field designated ‘cacheOrder’). Other information may be accessed as well depending on the information necessary for the operations to be performed. For example, a ‘cacheEnable’ attribute for each cache area may also be provided to indicate if the cache is enabled.

In an embodiment, upon start up the CMD 126 needs to determine how much space is being used by the files in the cache and how much free space is left on the drive so that it can keep the cache size within the ‘cacheMaxSize’ and ‘cacheMaxPercent’ limits.

In an embodiment, the CMD 126 loops through all the cache areas given in the ‘cacheAreasTable’ and checks to see if there is an entry for it in the ‘cacheSizeTable’ using the ‘path’ and ‘cachePath’ fields to match the entries between the two tables. If an entry is found the CMD 126 checks to see if ‘driveAvailable’ and ‘driveLeft’ fields are correct by comparing them with the total physical capacity for the drive and the actual space left on the drive. The ‘driveAvailable’ value should match exactly, but if the ‘driveLeft’ field is more than ‘driveLeftError’ different than the actual values or if there is no entry for this path in the ‘cacheSizeTable’ then the CMD 126 must build the cache model for this cache area. Otherwise the CMD 126 assumes that the cache model for the corresponding ‘path’ is correct and matches what is actually in cache. Note that, in an embodiment, the tolerance set by ‘driveLeftError’ is a guessed value and will need to be adjusted based on actual values at run time.

In order for the CMD 126 to efficiently delete the least recently used items from the cache it needs to keep a model of the items in each of the cache areas. This is referred to as the cache model. The CMD 126 keeps a separate cache model for each cache area. The cache model is stored in a database table given by ‘cacheModelTable’ with the ‘cacheAreaPath’ field used to logically separate the table for each cache area. In an embodiment, the table has the fields: ‘cacheAreaPath’, ‘filename’, ‘filesize’, ‘firstUsed’, ‘lastUsed’, ‘timesUsed’, ‘source’, ‘lastClient’ and ‘keep’. Alternative embodiments to the table described above for tracking what files are stored in the cache are also possible.

To build or synchronize the cache model of a particular cache area the CMD 126 loops through all the files that are in the cache area and creates or updates the entry for each file in the ‘cacheModelTable’. The ‘filename’ field is set to match that of the actual file. The filename may or may not include the extension depending on the embodiment. If the entry for this filename does not already exist then the remaining fields may be set as follows. The filesize may be set based on the actual size of the file. The ‘firstUsed’ field may be set based on the files create time. The ‘lastUsed’ field may be set based on the files modified time. The ‘timesUsed’ and ‘keep’ may be set to some predesignated value such as to 0, ‘source’ and ‘lastClient’ may be set to an empty string, and the ‘cacheAreaPath’ may be set to the full path of the cache area containing the file.

If the entry already exists then the following fields may be updated. The ‘filesize’ may be updated based on the file's actual size. The ‘lastUsed’ field may be set based on the files modified time. The other fields may retain their current values or also be updated.

If an entry exists in the ‘cacheModelTable’, but there is no file in the actual cache area then this entry is deleted from the cache model.

After building or synchronizing the cache model the CMD 126 may update the ‘cacheSizeTable’ to set the values for ‘driveAvailable’, ‘driveLeft’ and ‘cacheLeft’ for the appropriate cache area. The ‘driveAvailable’ is set to the total byte capacity of the drive. The ‘driveLeft’ is set to the free space on the drive (in bytes). The ‘cacheLeft’ is set to the ‘maxSize’ for that cache area minus the sum of the filesizes of all the items which the ‘cacheModelTable’ lists for that area.

In an embodiment, the CMD 126 runs in a main loop that constantly checks to see if there are any requests to be processed. If some part of a request requires substantial time to complete (like copying a file) it starts the appropriate process (or thread) to handle that part of the request and continues processing more requests. The CMD 126 can receive requests from the CCP 124 and the CCI 130. The CMD 126 first checks to see if there are any files in the ‘cacheRequestDir’ directory and processes them. It then checks to see if there are any files in the ‘cacheControlDir’ directory and processes those. The ‘cacheControlDir’ is a second table through which the CMD 126 may be directed to cache files by the system operator by processes that are not involved in the process of serving requests. The CMD 126 then loops again looking for files to process. If there are no files to be processed the CMD 126 sleeps for ‘pollWaitSeconds’ before checking again. The CMD 126 also has interrupt timers that are triggered every ‘healthWaitSeconds’ and ‘maintenanceWaitSeconds’ to cause it to run some health check and maintenance functions. The details of these functions are described later.

In an embodiment, the files in the various directories contain data, in a tabular or some other format, that list the requested files as processed by the CCP 124. Files may be limited so as to list a fixed number of requested files. Alternatively, the directories may themselves be a queue listing the requested files. Other methods are also possible for transmitting information from the CCP 124 to the CMD 126 for analysis, including adding file listings to a circular buffer or transmitting a message to the CMD 126 for each requested file. Any method of communicating the appropriate information between two programs, now know or later developed, may be utilized to support the operation of the system.

In the example embodiment, the CMD 126 gets a list of all the files listed in the ‘cacheRequestDir’ directory. Any file that does not begin with a number or otherwise conform to a standardized path scheme may be removed from the list. In an embodiment, the remaining files are sorted numerically in ascending order and processed one at a time. Note that if the timestamp is the leading number in the list, as described above, this serves to order the files by request time.

The information about the file is then read in from the list to get the fields stored. These fields are: ‘rFile’, ‘hitMiss’, ‘clientid’, ‘dateTime’, sPath’ and ‘waiting’. The ‘waiting’ field is optional and assumed to be “notwaiting” if not given. The file is then processed as follows.

If ‘disablecaching’ is set to “CMD”, the CMD 126 will not process the file, but rather deletes it as described below.

If the request for the file determined that the file was not in the cache, the request is a miss. The value for ‘hitMiss’ is set to “miss” or “precache” depending on whether the system is reading the ‘cacheRequestDir’ or the ‘cacheControlDir’. In addition, the CMD 126 sets a cacheTo variable for the file equal to the ‘path’ of the last cache area (highest ‘order’ number). However, if the hitMiss variable is set to “precache”, the ‘clientid’ field is checked as it will contain an identifier of the cache level into which to bring the file to based on cache ‘order’. However, if the ‘clientid’ is 0 the default is to bring it into the slowest (highest order) cache area.

Next, the CMD 126 will set the ‘cacheFrom’ variable equal to ‘sPath’ identified in the table being read. The size of the file at the source ‘sPath’ is then determined as described above. However, if the size can not be determined or the size is larger than some predetermined maximum size, the system may not cache the file or may cache it to a virtual cache area.

A virtual cache may be used depending on the embodiment of the caching policy selected. The policy of elevating to faster cache depends, at least in part, on the time at which an item was last accessed. However, this information may not be known for files on the filer (i.e., files not in the local cache). In an embodiment, the solution is to aggressively page in (i.e., copy into the cache) everything from the filer on first request. In another embodiment, a solution is to page in nothing from the filer on first request, but rather make a note in the virtual cache of when it was requested, and then elevate to the next faster level (i.e., to the slowest local cache) only when it is accessed a second time, and then only if it meets the same criteria used to elevate between two local caches. In yet another embodiment, a third option (described in the previous paragraph) is to stipulate a file size cutoff, and page in everything smaller on first request, while using the virtual cache for anything larger.

The CMD 126 may also check to see if the CCP 124 is waiting for this file to be cached by analyzing the waiting/nowaiting status.

If the file is of the size to be cached, the CMD 126 then loops through the cache areas in ascending order of the ‘order’ field. If the file can fit in a cache area based on the space left and limits set, the CMD 126 designates that the file be cached in that cache area by setting the cacheTo field equal to the ‘path’ of this cache area. The file is subsequently cached to the selected cache level by a copy process initiated by the CMD 126 and the CMD 126 proceeds to the next file to process in the table.

If when processing a file, the ‘hitMiss’ variable is set to “deleted”, the CMD 126 loops through the entry for this ‘rFile’ in all cache area models. If the file referenced in the ‘source’ field of the entry does not exist, then the file is deleted from the cache area and the entry is deleted from the cache area model. In addition, the ‘cacheSizeTable’ and other use metrics may be updated to include the new free space.

If the file was served from the cache (e.g., a cache hit) the ‘hitMiss’ variable is set to the cache area where the file was found. The CMD 126 then loops though the cache areas in ascending order of the ‘order’ field. If the cache model for this cache area has this ‘rFile’, then the cacheFrom field is set to the ‘path’ of this cache area. If the ‘order’ field of this cache area is greater than 1, the last ‘clientid’ for this ‘rFile’ is retrieved from the cache model. If the last ‘clientid’ is different from the current ‘clientid’ then the file meets one of the two criteria to be placed in a faster cache. In addition, for a file to be placed in a faster cache the CMD 126 selects the file with the oldest ‘lastUsed’ time from the cache area that is one lower in ‘order’ and compares this against the ‘lastUsed’ time of this file. If this file has a newer ‘lastUsed’ time then this file is placed in a faster cache. In an embodiment, the file to be moved to a lower order cache may simply be traded with the file or files being replaced, so that the file or files being replaced end up in the higher order cache. Alternatively, the file or files being replaced may be simply deleted from the cache.

In order to place the file in a faster cache, the cacheTo variable is set to the ‘path’ of the faster cache. In addition, the ‘lastUsed’ time in the cache model is updated to the ‘dateTime’ and the ‘timesUsed’ counter in the cache model is incremented. The CMD 126 then frees enough space in the lower order cache and the ‘driveLeft’ and ‘cacheLeft’ fields of ‘cacheUsedTable’ are updated.

In an embodiment, if the ‘waiting’ variable is set to indicate the CCP 124 is waiting for the CMD 126 to cache the file, a high priority process is started to copy the file from ‘cacheFrom’ to ‘cacheTo’. Otherwise, a general process is used to copy files. After a file is copied, an entry is added for the ‘rFile’ in the cache model. In an embodiment, the ‘hitMiss’ variable is set to “precache”, the ‘keep’ field in the cache model is set to 1 so that the file is kept in that cache until deleted by an explicit “delete” command. This prevents a precached file from being deleted out because of normal request file processing and caching.

To free enough space in the cache area the CMD 126 may check if the file to be brought into cache is already in any of the cache areas. This may happen if the file is in cache but is stale because the source file has changed. If it is the case that the modified time of the file in cache is older than the modified time of the source file then the file is deleted from all cache areas and the cache model tables. The ‘cacheSizeTable’ is updated to include the new free space. Otherwise the file in cache is in sync and does not need to be brought into cache.

Alternatively and as described above, the CCP 124 may flag any stale files to the CMD 126. In this embodiment, the CMD 126 does not need to actively check to determine if the file to be brought into the cache is already in any of the cache areas, as it will be notified of the fact by the CCP 124. The CMD 126, in response to the stale notification, then replaces the stale file, in whatever cache level it happens to reside, with a copy of the current source file. In an embodiment, the CMD 126 look to determine if multiple copies of the source file exist in different cache levels and delete any stale copies found in higher order caches as well as replacing the copy in the lowest order cache.

In yet another embodiment, stale copies may be ignored by the CMD 126. This allows, in the normal process of caching requesting files, the system to drive any stale files out of the system over time as there will be no requests for the stale files and these files will rapidly become the least recently requested files in the cache and be deleted to make space available for more popular files.

In addition, if more space is still needed the CMD 126 may select some number of the least recently used files, e.g., 10, 50, 100, etc., (based on the ‘lastUsed’ field) from the cache model sorted with the least recently used file first. Files that have the ‘keep’ field set to 1 are excluded from the selection. The CMD 126 then loops through the list and deletes enough files from the cache area so that the cache area limits would not be exceeded with the addition of the file. The entries for the deleted files are also removed from the cache model. The ‘cacheSizeTable’ is updated with the new calculated values for ‘driveLeft’ and ‘cacheLeft’. However, before deleting a file the CMD 126 may need to check if the last modified time of the file in cache is the same as the ‘lastUsed’ field in the cache model. If it is not, this means the file may be in the process of being served from cache and should not be deleted.

In an embodiment, to copy a file to any cache the CMD 126 first needs to determine the full path of the ‘cacheFrom’ and ‘cacheTo’ and pass these to the process that will do the copy. To do this the CMD 126 may need to determine the subdirectory and filename. It will already know the path of the cache areas. The subdirectory and filename will be determined as described above with respect to the CCP 124.

To update the hit/miss statistics the CMD 126 may write a statistics table or other data structure. In an embodiment, the CMD 126 writes to a table referred to as the ‘statsTable’. The ‘path’ field of this table may be the cache area path or the string “miss”, “nocache”, or “disabled”. This string is provided as the ‘hitMiss’ field in the request file. The ‘minute’ field of this table is an integer count of the number of minutes since Jan. 1, 1970 GMT. This field helps to consolidate the stats into one minute buckets. To determine this value the CMD 126 takes the current timestamp and keeps only the integer after dividing it by 60. Whenever a request is served from a cache a ‘reqCount’ variable may be incremented and ‘reqBytes’ is increased by the size of the file (in bytes) that was served for the appropriate bucket. If the request was not served from cache the ‘path’ would be the string “miss”. Whenever a file is brought into cache the ‘inCount’ and ‘inBytes’ fileds may be increased for the appropriate bucket. Whenever a file is removed from the cache the ‘outCount’ and ‘outBytes’ may similarly be increased for the appropriate bucket.

For the purposes of an example of an embodiment of the system, which example is meant to be illustrative and not limiting, consider a request that was a miss in which the CCP 124 serves the request from the original source and does not wait for it to be brought into cache. The “miss” bucket for this minute would have ‘reqcount’ incremented and ‘reqBytes’ increased by the size of the file in bytes. If this file is brought into cache the bucket defined by the cache area and minute would also have the ‘inCount’ and ‘inBytes’ parameters increased. If other files had to be removed from the cache to make space for the incoming file then this bucket would also have the ‘outCount’ and ‘outBytes’ fields increased.

As another example of an embodiment of the system, which example is meant to be illustrative and not limiting, consider a request that was a miss in which the CCP 124 waited for the request to be brought into cache before serving it. The ‘reqcount’ and ‘reqBytes’ for the bucket defined by the current minute and the cache area to which the file was brought in would be increased. The same bucket would also have the ‘inCount’, ‘inBytes’, ‘outCount’ and ‘outBytes’ fields increased as described in the previous example.

As yet another example of an embodiment of the system, which example is meant to be illustrative and not limiting, consider a request that was a hit and served from a cache area. The appropriate bucket would have the ‘reqcount’ and ‘reqBytes’ fields increased. If the CMD 126 decided to move the file to a faster cache area then the appropriate bucket for that cache area would have the ‘inCount’, ‘inBytes’, ‘outCount’ and ‘outBytes’ fields increased as described in the first example.

When updating the ‘transferRatesTable’ the CMD 126 may determine the ‘source’ from the ‘from’ field of the ‘copyProgressTable’. The CMD 126 will determine the transfer time to be the current time minus the ‘started’ time. If this time is less than 5 seconds then this transfer was too small to give an accurate value and no update is done. Otherwise the rate of this transfer ‘thisRate’ is determined to be the ‘filesize’ divided by the transfer time taken as an integer. The ‘rate’ for this ‘source’ is updated to be (5*‘rate’+‘thisRate)/6. The ‘rate’ is initially defaulted to 1.

The CCI 130 provides a set of web based services (some for programs and others for humans) that run on the same host as the Media Server and can be invoked to control and monitor the caching system. The functionality provided includes: Setting, changing and viewing configuration parameters; Forcing a file to be brought into cache at a specified time with the option to have the file removed at a specified time or after a duration; Forcing a file to be removed from cache; Reading the status of the cache; number of files in cache areas; files being copied, etc.; Reading the hit/miss statistics of the cache; Viewing the items that were forced into cache; Allowing them to be removed manually; and Viewing error logs of CCP 124 and CMD 126. Some of these services will require reading files or database tables and returning the data in a formatted way. Others will require updating database tables or writing to files that are read by the CCP 124 and CMD 126.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of the present invention. For example, multiple cache levels may be used that have the same performance (e.g., multiple disk drives) and the system may be used to manage these caches as well by arbitrarily giving them different orders. Numerous other changes may be made which will readily suggest themselves to those skilled in the art and which are encompassed in the spirit of the invention disclosed and as defined in the appended claims.

What is claimed is:

1. A computer-readable medium encoding computer-readable instructions for performing a method of caching requested files, the method comprising:
receiving a request for a requested file stored in a remote storage location, a copy of the requested file also stored in a first cache level of a local cache, the local cache including a plurality of different cache levels including the first cache level, each cache level in the plurality of different cache levels having different performance characteristics;
searching the local cache for the requested file wherein the different cache levels are searched in an order based on the different performance characteristics;
adding information identifying the requested file to a list of files;
serving the copy of the requested file from the first cache level;
reading the list of files; and
in response to reading the information identifying the requested file, moving the requested file from the first cache level to a second cache level, the second cache level being a faster cache level in the plurality of cache levels relative to the first cache level.

2. The computer-readable medium of claim 1 wherein the instructions further comprise instructions for:
changing a modification date of the copy of the requested file based on a time when the request was received.

3. The computer-readable medium of claim 1 wherein serving further comprises:
comparing the copy of the requested file with the requested file stored in a remote storage location; and
serving the copy only if the requested file stored in a remote storage location has not been changed since the copy of the requested file was made.

4. The computer-readable medium of claim 1 wherein moving further comprises:
comparing the modification date of the copy of the requested file with modification dates of cached files stored in at least one faster cache level in the plurality of cache levels relative to the first cache level.

5. The computer-readable medium of claim 4, wherein the method further comprises:
moving only if the comparing operation identifies at least one cached file with a modification date less recent than the modification date of the requested file.

6. The computer-readable medium of claim 1 wherein the requested file is requested by a user having a first user identifier and moving further comprises:
comparing the user identifier with a last requestor identifier associated with the copy of the requested file.

7. The computer-readable medium of claim 6 wherein the method further comprises:
moving only if the user identifier and the last requestor identifier identify different users.

8. The computer-readable medium of claim 5 wherein the method further comprises:
identifying a fastest cache level with at least one cached file with a modification date less recent than the modification date of the requested file; and
selecting, as the second cache level, the fastest cache level with at least one cached file with a modification date less recent than the modification date of the requested file.

9. The computer-readable medium of claim 2 wherein moving further comprises:
deleting at least one cached file with a modification date less recent than the modification date of the requested file from the second cache level.

10. The computer-readable medium of claim 3 wherein the method further comprises:
if the requested file stored in a remote storage location has been changed since the copy of the requested file was made,
serving the requested file; and
replacing the copy of the requested file in the first cache level with a new copy of the requested file.

11. A method of caching requested files in a cache having a plurality of different levels with different performance characteristics, the method comprising:
receiving a request for a requested file in a remote storage location;
determining that a copy of the requested file is not contained in a cache based on a search of each of the plurality of different levels of the cache performed in an order based on the different performance characteristics; and
adding information identifying the requested file to a list of files to be copied from the remote storage location into the cache.

12. The method of claim 11 further comprising:
retrieving the requested file from the remote storage location; and
transmitting the requested file in accordance with the request.

13. The method of claim 11 wherein each level is associated with a different speed and the method further comprises:
searching each of the plurality of different levels of the cache descending order of speed, starting with a fastest level and ending with a slowest level.

14. The method of claim 13 further comprising:
accessing information identifying a transfer rate associated with the remote storage location; and
comparing the transfer rate with a predetermined threshold.

15. The method of claim 14 further comprising:
based on results of the comparing operation, retrieving the requested file from the remote storage location; and
transmitting the requested file in accordance with the request.

16. The method of claim 14 further comprising:
based on results of the comparing operation, repeating the searching operation; and
if a copy of the requested file is subsequently located in the cache, transmitting the copy of the requested file from the cache in accordance with the request.

17. The method of claim 14 further comprising:
based on results of the comparing operation, repeating the searching operation; and
if a copy of the requested file is not subsequently located in the cache prior to the expiration of a timeout period, retrieving the requested file from the remote storage location; and
transmitting the requested file in accordance with the request.

18. A method of caching requested files comprising:
receiving a notification of a request for a requested file stored in a remote storage location and the requested file not contained in a cache, the cache comprising a plurality of different levels with different performance characteristics;
retrieving a file size of the requested file; and
searching, in an order based on the different performance characteristics, the plurality of different levels of the cache for sufficient available space to store the requested file, based on the file size.

19. The method of claim 18 further comprising:
copying the requested file from the remote storage location to the first cache encountered having sufficient available space to store the requested file.

20. The method of claim 19 wherein each level is associated with a different speed and searching further comprises:
searching each of the plurality of different levels of the cache descending order of speed, starting with a fastest level and ending with a slowest level.

21. The method of claim 18 wherein each of the plurality of different levels corresponds to a different storage device included in the cache and searching further comprises:
searching each of the different storage devices of the cache.

22. The method of claim 18 further comprising:
if none of the levels of the cache have sufficient available space to store the requested file, deleting files from a slowest level; and
copying the requested file from the remote storage location to the slowest level.

23. The method of claim 22 wherein deleting further comprises:
identifying one or more least recently requested files stored in the slowest level; and
deleting the one or more least recently requested files until sufficient space is available to store the requested file.

24. A method of caching requested files comprising:
receiving a request for a requested file stored in a remote storage location, a copy of the requested file also stored in a first cache level of a local cache, the local cache including a plurality of different cache levels including the first cache level, each cache level in the plurality of different cache levels having different performance characteristics;
serving the copy of the requested file from the first cache level; and
moving the requested file from the first cache level to a second cache level, the second cache level being a faster cache level in the plurality of cache levels relative to the first cache level.

25. The method of claim 24 further comprising:
changing a modification date of the copy of the requested file based on a time when the request was received.

26. The method of claim 24 wherein serving further comprises:
comparing the copy of the requested file with the requested file stored in a remote storage location; and
serving the copy only if the requested file stored in a remote storage location has not been changed since the copy of the requested file was made.

27. The method of claim 24 wherein moving further comprises:
comparing the modification date of the copy of the requested file with modification dates of cached files stored in at least one faster cache level in the plurality of cache levels relative to the first cache level.

28. The method of claim 27 further comprising:
moving only if the comparing operation identifies at least one cached file with a modification date less recent than the modification date of the requested file.

29. The method of claim 24 wherein the requested file is requested by a user having a first user identifier and moving further comprises:
comparing the user identifier with a last requester identifier associated with the copy of the requested file.

30. The method of claim 29 further comprising:
moving only if the user identifier and the last requestor identifier identify different users.

31. The method of claim 28 further comprising:
identifying a fastest cache level with at least one cached file with a modification date less recent than the modification date of the requested file; and
selecting, as the second cache level, the fastest cache level with at least one cached file with a modification date less recent than the modification date of the requested file.

32. The method of claim 25 wherein moving further comprises:
deleting at least one cached file with a modification date less recent than the modification date of the requested file from the second cache level.

33. The method of claim 26 further comprising:
if the requested file stored in a remote storage location has been changed since the copy of the requested file was made,
serving the requested file; and
replacing the copy of the requested file in first cache level with a new copy of the requested file.

34. A system for serving data to a client computing device comprising:
a media server module that receives client requests for files stored in one or more remote storage devices;
a local cache storing at least one copy of one or more files stored in the one or more remote storage devices, the local cache including a plurality of different cache levels, each cache level in the plurality of different cache levels having different performance characteristics;
a cache management module that moves cached files from a slower cache level to a faster cache level in response to request notifications; and
a caching component that transmits request notifications to the cache management module in response to client requests received by the media server module, each notification identifying a requested file and whether a copy of the requested file exists in the cache.

35. The system of claim 34 wherein the caching component, upon receipt of a client request, searches the cache for a copy of the requested file and, if the copy is found, causes the copy to be transmitted as directed by the client request.

36. The system of claim 34 wherein the cache management module creates a copy of the requested file and stores it in the fastest cache level with space available if no copy of the requested file exists when the notification was transmitted.

37. The system of claim 34 wherein the cache management module moves the copy of the requested file to a faster cache level only if at least one cached file in the faster cache level has a modification date less recent than a request time associated with the request for the requested file.

38. The system of claim 34 wherein the caching component accesses information about the one or more remote storage devices and waits for the cache management module to cache a copy of the requested file based on the information about the one or more remote storage devices and a predetermined threshold.

39. The system of claim 34 wherein the cache management module moves a cached file from a slower cache level to a faster cache level only if the client request identifies a client different from a last client associated with the cached file.
